(19) United States
(12) Patent Application Publication
(10) Pub. No.: US 2012/0296835 A1
(43) Pub. Date: Nov. 22, 2012

(54) PATENT SCORING AND CLASSIFICATION

(75) Inventors: Arif Khan K, Dvangere (IN); Rahul Jindal, North Sydney (AU)

(73) Assignee: CPA SOFTWARE LIMITED, St. Helier (UK)

(21) Appl. No.: 13/575,126

(22) PCT Filed: Jan. 25, 2010
(86) PCT No.: PCT/IB2010/000335

§ 371 Date: Jul. 25, 2012

(51) Int. Cl. G06Q 50/26

(52) U.S. Cl. 705/310

(57) ABSTRACT

A method, system, and apparatus for classifying intangible assets are provided. The method includes determining an objective of classification. The method further includes constructing, via a processor, a Discriminant Analysis (DA) model using one or more test sets of intangible assets. The DA model includes one or more discriminant functions operable to classify the one or more test set of intangible assets into two or more groups based on a set of attributes associated with one or more intangible assets of the test set of intangible assets to meet the objective of classification. Thereafter, the method includes classifying a target set of intangible assets via the DA model.

### FIELD

This application relates generally to analysis of intellectual property, and in some embodiments to computer systems and processes for scoring and/or classifying intangible assets (e.g., patents and/or patent applications) based on certain criteria.

### BACKGROUND

Intangible assets, such as patents and trademarks, are vital to society and the economy. They provide incentives for individual inventors and corporations to engage in research and development (R&D). Without patents, third parties will be free to exploit any new inventions, with the result that fewer inventors and corporations will be willing to invest in R&D and technological advances will be stifled.

A patent portfolio may help a business to protect its investments, revenues and assets. For example, a strong patent portfolio may create barriers to entry for competitors and preserve an exclusive market space for products and services offered by a business. A patent portfolio may be valuable to a business because it generates revenue through patent licensing or assignments. It may be a powerful bargaining tool for obtaining access to other patented technologies, e.g., by cross-licensing. A patent portfolio may also serve as a defensive tool when facing a patent infringement suit. For example, a company with a broad and strong patent portfolio may counter-sue for infringement of its own patents and force the suing party into settlement quickly.

However, patents have varying quality and value. A large number of patents of varying quality and value get filed every year in various technological fields in different countries across the world. Some of these patents protect a company's core technologies, while others protect non-core technologies or merely small incremental improvements from well-known technologies.

Furthermore, the cost of developing, maintaining, or acquiring a patent portfolio may be substantial. Therefore, a business should evaluate the value of its patent portfolio on a regular basis, and devise a patent portfolio strategy that is aligned with the company's business objectives. For example, a company may decide to abandon or sell its non-core patents which are of low value to the company. Conversely, a company may decide to maintain or renew a core, high-value patent or even file additional members within the same patent family.

Therefore, having a systematic and objective way of assessing the quality, value, or strength of a patent may be very useful for a number of purposes. For example, a company may use such information to make better business decisions in various aspects, including but not limited to R&D spending, product development, resources allocation, strategic patent prosecution, licensing or litigation, competitive intelligence and benchmarking, and the like. An investor may use such information to better estimate different companies' expected asset value. A lender may use such information to estimate the risk associated with extending a loan that is secured by a company's assets, including its patent portfolio.

### SUMMARY

In accordance with an aspect of the invention a method for classifying intangible assets is provided. The method includes determining an objective of classification. The method further includes constructing, via a processor, a Discriminant Analysis (DA) model using one or more test sets of intangible assets. The DA model includes one or more discriminant functions operable to classify the one or more test set of intangible assets into two or more groups based on a set of attributes associated with one or more intangible assets of the test set of intangible assets to meet the objective of classification. Thereafter, the method includes classifying a target set of intangible assets via the DA model.

In accordance with another aspect of the invention, a method for constructing a Discriminant Analysis (DA) model for classifying intangible assets is provided. The method includes deriving, via a processor, one or more discriminant functions operable to classify a test set of intangible assets into two or more groups based on a set of attributes associated with one or more intangible assets of the test set of intangible assets. The one or more discriminant functions comprising a combination of weighted attributes from the set of attributes.

In accordance with yet another aspect of the invention, a method for classifying intangible assets is provided. The method includes classifying a set of intangible assets based on a DA model via a processor. The DA model comprising one or more discriminant functions operable to classify the set of intangible assets into two or more groups based on a set of attributes associated with one or more intangible assets of the set of intangible assets.

In accordance with an aspect of the invention, a DA model for classifying intangible assets is provided. The DA model includes one or more discriminant functions operable to classify a set of intangible assets into two or more groups based on a set of attributes associated with each intangible asset of the set of intangible assets. The one or more discriminant functions include a combination of weighted attributes from the set of attributes.

In accordance with another aspect of the invention, a computer-readable storage medium comprising computer-executable instructions for classifying intangible assets is provides. The instructions include constructing a DA model using one or more test sets of intangible assets. The DA model includes one or more discriminant functions operable to classify the one or more test sets of intangible assets into two or more groups based on a set of attributes associated with one or more intangible assets of the one or more test sets of intangible assets. The instructions further include classifying a target set of intangible assets via the DA model.

In accordance with yet another aspect of the invention, an apparatus for classifying intangible assets is provided. The apparatus includes a processor configured to construct a DA model using one or more test sets of intangible assets. The DA model includes one or more discriminant functions operable to classify the one or more test sets of intangible assets into two or more groups based on a set of attributes associated with one or more intangible assets of the one or more test sets of intangible assets. The processor is further configured to classify a target set of intangible assets via the DA model.

In accordance with an aspect of the invention, an apparatus for classifying intangible assets is provided. The apparatus includes means for constructing a DA model using one or more test sets of intangible assets. The DA model includes one or more discriminant functions operable to classify the one or more test sets of intangible assets into two or more groups based on a set of attributes associated with one or more intangible assets of the one or more test sets of intangible assets. The apparatus further includes means for classifying a target set of intangible assets via the DA model.

### BRIEF DESCRIPTION OF THE FIGURES

The present application can be best understood by reference to the following description taken in conjunction with the accompanying drawing figures, in which like parts may be referred to by like numerals:

FIG. 1 is a flowchart of a method of classifying intangible assets, in accordance with an embodiment.

FIG. 2 is a flowchart for refining a DA model, in accordance with an embodiment.

FIG. 3 is a flowchart of a method for constructing a DA model for classifying intangible assets, in accordance with an embodiment.

FIG. 4 is a flowchart of a method for classifying intangible assets, in accordance with an embodiment.

FIG. 5 is a graphic illustration of separating two exemplary groups of objects or events associated with patent assets or intellectual property assets using Linear Discriminant Analysis (LDA).

FIG. 6 illustrates two exemplary groups, wherein the variance between the groups is large relative to the variance within the groups.

FIG. 7 illustrates a flow chart of an exemplary process for constructing a patent scoring and classifying model, in accordance with an embodiment.

FIG. 8 illustrates an exemplary computing system that may be employed to implement processing functionality for various embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

Various embodiments provide methods and systems for classifying intangible assets. An intangible asset may include, but is not limited to a patent, a patent application, a trademark, and a copyright. For the classification, an exemplary Discriminant Analysis (DA) model may be used to assign scores to the intangible assets, which are then used to classify the intangible assets. DA is a multivariate statistical analysis and machine learning technique that is used to determine attributes (also known as features, predictor variables, metric/non-metric independent variables, and the like) that discriminate between two or more groups of objects (for example, intangible assets). Based on these attributes, DA is further used to identify the group to which an object belongs.

The exemplary DA model may be a Linear DA (LDA) model. LDA is a statistical analysis and machine learning technique that is used to find the linear combination of attributes that discriminate two or more groups of objects. In LDA, rather than relying on each attribute as a separate predictor of group classification, a weighted combination of attributes is used to predict relevant group classification of an object.

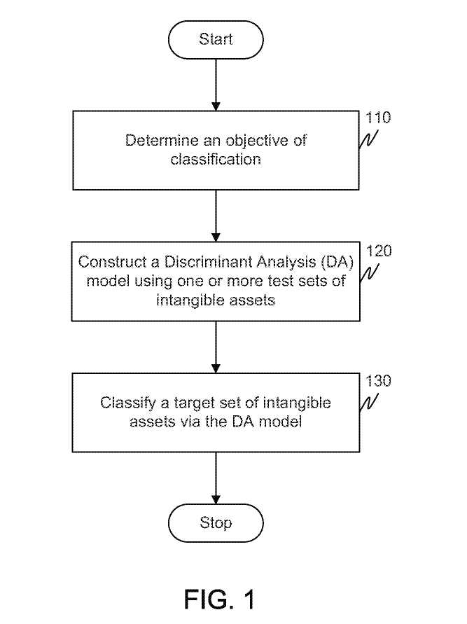

FIG. 1 is a flowchart of method of classifying intangible assets, in accordance with an embodiment. At 110 a user determines an objective of classification. The objective of classification includes potential valuation, litigation likelihood/outcome, potential commercialization, or subsequent renewal/abandonment decisions. For example, a user may want to determine high value patents and low value patents in a patent portfolio. In this case, the user will select potential valuation as the objective of classification. By way of another example, the user may want to determine the patents which will most likely be used for product making. In this case, the user will select potential commercialization as the objective of classification. In an embodiment, multiple objectives of classification may be displayed to a user through a User Interface (UI). The UI may be a web based UI. For example, a drop down menu may be use to display the multiple objective of classification and the user may select one of them from the drop down menu. Alternatively, the objective of classification may be conveyed using various means of communication.

Based on the objective of classification determined by the user, a processor constructs a Discriminant Analysis (DA) model using one or more test sets of intangible assets at 120. In an embodiment, the DA model may be constructed specific to a particular technology. Therefore, there are multiple DA models that cater to multiple technology fields. This is very helpful in performing an accurate classification of intangible assets in a specific technology field. For constructing the DA model specific to a particular technology, the one or more test sets of intangible assets used also belong to the particular technology. For example, if the DA model is to be constructed for classifying patent in the field of nanoparticles, a test set of patent assets used for constructing the DA model includes patents in the field of nanoparticles.

Additionally, one of the one or more test sets of intangible assets is associated with one of the objective of classification. Test sets of intangible assets are built based on one or more objectives of classification. Thus, for each objective of classification there is a specific test set of intangible assets. When an objective of classification is selected by the user, the processor uses a test set of intangible assets built for the objective of classification to classify a target set of intangible assets. For example, the user selects patent valuation as the object of classification of a target set of patents. To facilitate the classification, the processor selects a test set of patents that includes high value patents and low value patents. By way of another example, the user may select litigation likelihood/outcome as the objective of classification of a target set of patents. To facilitate this, the processor selects a test set of patents that includes patents that have lost in litigation and patents that have won in litigations.

Further, the one or more test sets of intangible assets include a set of intangible assets that have a known or a predefined value or an outcome for a given objective. For example, in a test set of patents built for patent valuation, the value of one or more patents in the test set of patents is known. By way of another example, in a test set of patents that is built for the objective of subsequent renewal/abandonment decisions, the outcome for patents in the test set of patents is already know, i.e., when were they abandoned or how many times they were renewed.

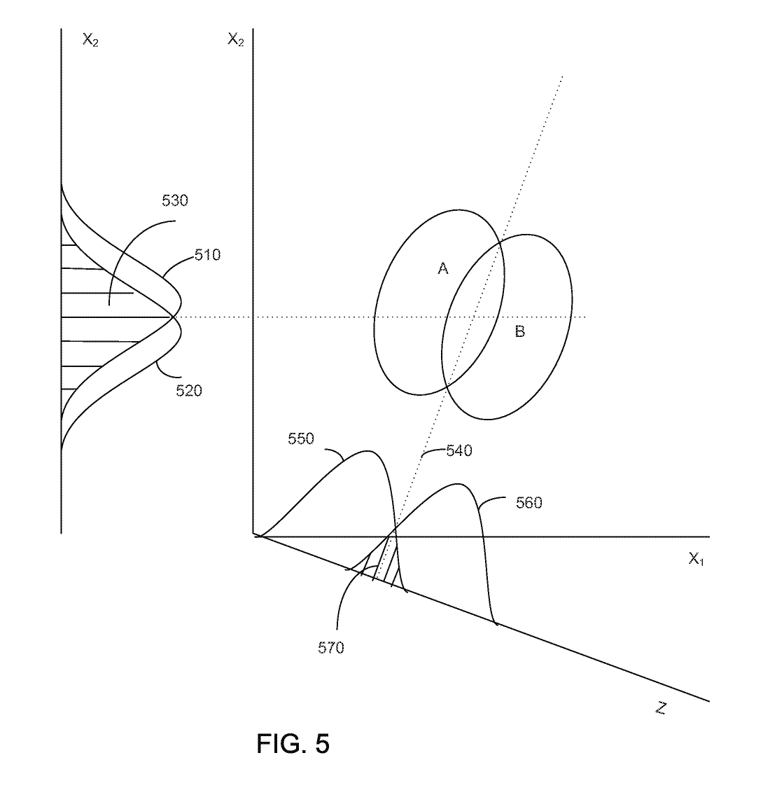

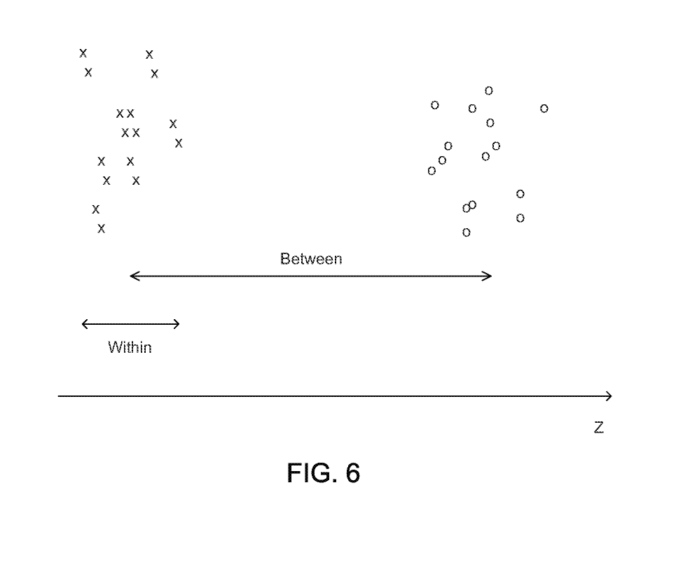

After identifying a test set of intangible assets and constructing the DA model, one or more discriminant functions in the DA model classify the one or more test sets of intangible assets into two or more groups to meet the objective of classification. The DA model may include a Linear Discriminant Analysis (LDA) model. In this case, the one or more discriminant functions include one or more linear discriminant functions. The LDA model and linear discriminant functions are explained in detail in conjunction with FIG. 5 and FIG. 6.

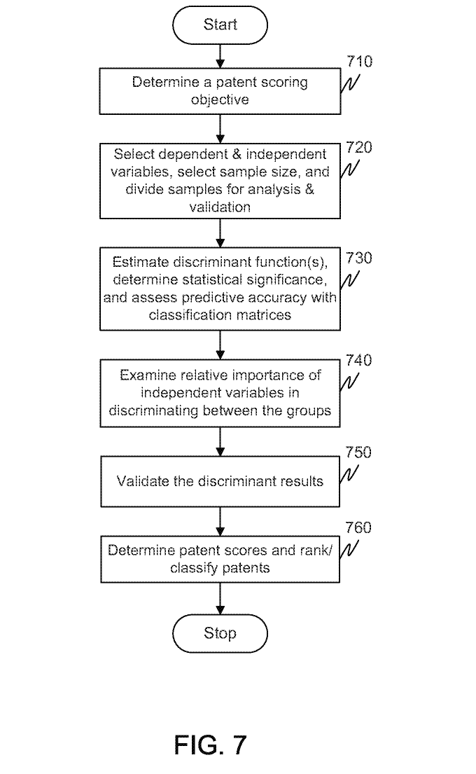

The classification is performed based on a set of attributes associated with one or more intangible assets of the one or more test sets of intangible assets. The set of attributes used for the DA model are selected using one of more various methods of investigation and analysis. Examples of such methods include reviews of relevant literature discussing attributes, opinions from experts, interviews with asset owners, and empirical analysis. The association of attributes with different groups of patents or other intangible assets in the test set and the relative importance of the attributes are determined by the DA model. Examples of an attribute for patent may include, but are not limited to the number of independent claims in a patent, the number of dependent claims in a patent, the age of a patent, and number of statutory classes covered in the claims. The Attributes for patents are further explained in conjunction with Table 1 in the description of FIG. 7. If the intangible assets are trademark, examples of attributes may include, but are not limited to age of the trademark, total sales under the trademark; recall, recognition, or awareness of the trademark; association with the trademark; goodwill associated with the trademark; geographical or jurisdictional rights of the trademark; number of licensees or value of license of the trademark; and renewal history of the trademark.

The one or more discriminant functions include a combination of weighted attributes from the set of attributes. Weights are determined using the one or more discriminant functions and represent the relative importance of the associated attributes. Discriminant functions are explained in detail in conjunction with FIG. 5. The one or more discriminant functions may not be able to compute weights for some attributes. For these attributes, a correlation is determined between an attribute that has an unknown weight and an attribute that has a known weight. Thereafter, a correlation factor is applied to the weight of the attribute having the known weight to determine weight of the attribute that had the unknown weight. This may be represented as equation (1)

W_{Xu}=a(W_{Xk}) (1)

Where,
W_{Xu}=Weight of the unknown attribute Xᵤ
W_{Xk}=Weight of the known attribute Xₖ
a=Correlation coefficient
   For example, two attributes, “the age of a patent” and “the number of renewals for the patent”, have a direct correlation as the age of the patent that has undergone more number of renewals will be more. If a discriminant function is able to determine weight associated with “the age of a patent,” and the discriminant function is not able to determine weight associated with “the number of renewals of the patent,” then a correlation factor between these two attributes for the patent is computed. Thereafter, to determine weight for “the number of renewals of the patent”, the correlation factor is applied to the weight associated with “the age of a patent”. Additionally, this can act as a correction factor to increase the predictive power of the DA model.

After determining weights for attributes using the DA model, a sum product function is used to compute one or more output scores for one or more intangible assets in a test set of intangible assets. An output score for an intangible asset is determined when weights are multiplied with associated attributes of the intangible asset. The one or more output scores are used to classify the one or more intangible assets. In an embodiment, the one or more output scores are used to segment the test set of intangible assets into two or more groups. For example, a test set of intangible assets includes ten patents. For each of these ten patents, an output score is determined using the DA model with potential valuation as the objective of classification. An output score ranging from 1 to 5 is determined via the DA model. Thereafter, the patents having an output score from 1 to 3 are segregated as low value and the patents having an output score from 4 to 5 are segregated as high value patents and vice versa.

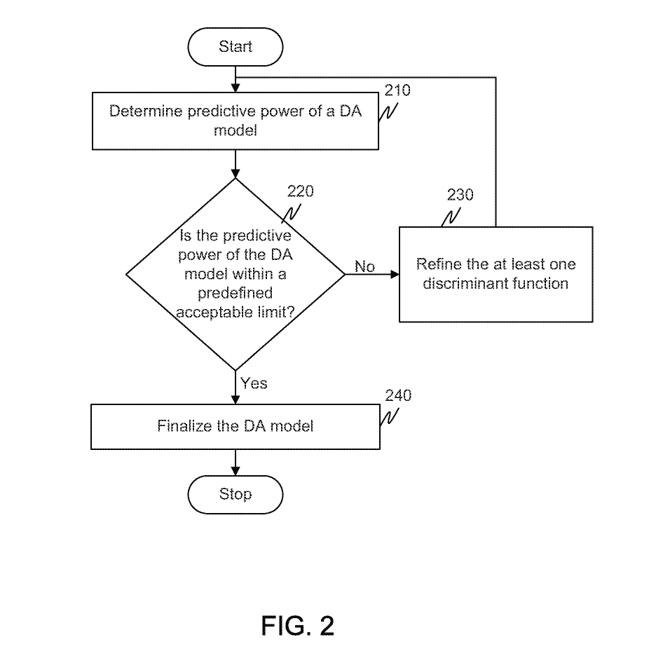

The DA model may be validated using a plurality of statistical tools. The plurality of statistical tools may include, but are not limited to an Analysis of Variance (ANOVA) test, a Spearman's rank correlation test, a Chi-squared Automatic Interaction Detector (CHAID) test, and a Wilk's lamba test. The validation of the DA model ensures that the classification done by the DA model is accurate. In an embodiment, to further improve the predictive power of the DA model, the one or more discriminant functions are iteratively refined. This is further explained in conjunction with FIG. 2.

After construction, validation, and refinement of the DA model, a target set of intangible assets is classified via the DA model at 130. In an embodiment, the DA model may be used without validation and refinement. The DA model is used to compute one or more output scores for one or more intangible assets in the target set of intangible assets. The one or more output scores may then be used to segment the target set of intangible assets into two or more groups. The DA model may be constructed specific to a particular technology domain. Therefore, if the target set of intangible assets is in the telecommunication domain, the DA model will be specifically constructed for the telecommunication domain. Alternatively, the DA model may be constructed such that it is generally applicable to multiple technology domains.

The DA model is constructed using a test set of intangible assets that is specific for a particular objective of classification and a particular technology field. Such DA models, which are constructed specifically for an objective and a technology field, may classify a target set of patent assets accurately. Moreover, as multiple DA models are already constructed for various objectives of classification and various technology fields, a user simply needs to select an objective of classification and indicate the technology field of a target set of patent assets. This provides the user with a DA model that may be used to segment the target set of patent assets.

FIG. 2 is a flowchart for refining a DA model, in accordance with an embodiment. The DA model is constructed by a processor using one or more test sets of intangible assets based on a set of attributes. The one or more test set of intangible assets include a set of intangible assets that have one of a known value, a known outcome, a predefined value, and a predefined outcome. After construction, the DA model is used to classify/segment a test set of intangible assets into two or more groups. This has been explained in detail in conjunction with FIG. 1.

To improve the accuracy of the DA model, the processor determines a predictive power of the DA model at 210. The predictive power is determined by validating the classification of the test set of intangible assets against one of the known value, the known outcome, the predefined value, and the predefined outcome. For example, a test set of patent assets, which is built for the objective of potential valuation, is used to construct a DA model. In the test set of patents, the monetary value of each patent is known. Based on these known values, the test set of patents may be divided into exemplary groups such as the following three groups, namely, high value patents, medium value patents, and low value patents. Thereafter, the DA model is used to divide the test set of patents into these three groups. The grouping of patents based on the value of patents is compared and validated with the grouping of the patents made using the DA model. Based on the comparison, if these groupings match very closely, then the DA model has a good predictive power.

Thereafter, at 220 a check is performed to determine if a predictive power of the DA model is within a predefined acceptable limit. In continuation of the example given above, the predefined acceptable limit for the predictive power may be set as 80%, however this exemplary and limit is non-limiting and could be set higher or lower. In other words, when the grouping of patents based on the value of patents is compared and validated with the grouping of the patents made using the DA model, there should be at least an 80% match in the groupings. If the percentage of patents, for which the groupings match, is less than 80%, the predictive power of the DA model is not acceptable.

If the predictive power of the DA model is not within the predefined acceptable limit, one or more discriminant functions in the DA model are refined at 230. For example, if the percentage of patents, for which the groupings match, is less than 80%, one or more discriminant functions in the DA model are refined. Thereafter, 210 and 220 are repeated.

Thus, the process of refining the one or more discriminant functions is performed iteratively until the predictive power of the DA model is within the predefined acceptable limit. To refine the one or more discriminant functions, a weight associated with a corresponding attribute is adjusted for one or more attributes of the set of attributes. Adjusting weights may include applying a correction factor to weights associated with one or more attributes. Referring back to step 220, if the predictive power of the DA model is within the predefined acceptable limit, the DA model is finalized at 240.

The iterative refining of the DA model improves the accuracy of the DA model. Moreover, as the refining is performed by comparing with a test set that has known outcome/value, the final DA model may be convincingly used to classify a target set of patents accurately.

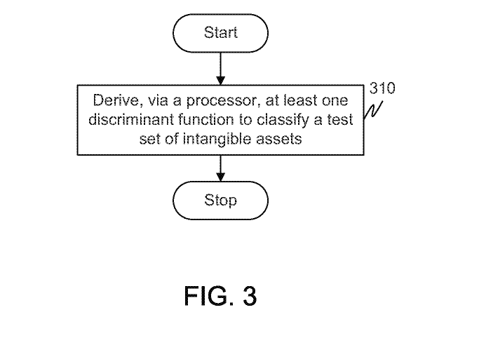

FIG. 3 is a flowchart of a method for constructing a DA model for classifying intangible assets, in accordance with an embodiment. At 310 a processor derives one or more discriminant functions. The one or more discriminant functions are derived to meet an objective of classification. The objective of classification has been explained in detail in conjunction with FIG. 1.

The one or more discriminant functions are operable to classify a test set of intangible assets into two or more groups based on a set of attributes associated with one or more intangible assets of the test set of intangible assets. The one or more discriminant functions include a combination of weighted attributes from the set of attributes.

To derive the one or more discriminant functions, a predictive power of the DA model is determined. Thereafter, the one or more discriminant functions are iteratively refined to bring the predictive power within a predefined acceptable limit. The DA model may also be validated using a plurality of statistical tools to check the accuracy of the DA model. This has been explained in detail in conjunction with FIG. 2.

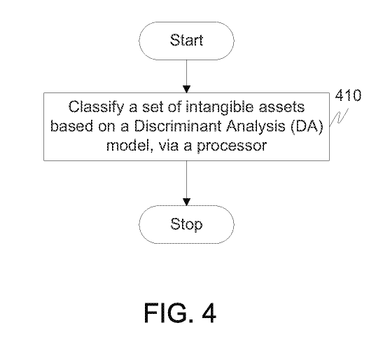

FIG. 4 is a flowchart of a method for classifying intangible assets, in accordance with an embodiment. A user determined an objective of classification. A DA model is configured to meet the objective of classification. Based on the objective of classification determined by the user, a processor classifies a set of intangible assets based on a DA model, at 410. The DA model includes one or more discriminant functions that are operable to classify the set of intangible assets into two or more groups based on a set of attributes associated with one or more intangible assets of the set of intangible assets. This has been explained in detail in conjunction with FIG. 1.

For classifying the set of intangible assets, an output score is generated for each intangible asset in the set of intangible assets using the DA model. Based on output scores, the set of intangible assets are segmented into two or more groups. This has been explained in detail in conjunction with FIG. 1.

FIG. 5 is a graphic illustration of separating two exemplary groups of objects or events associated with patent assets or intellectual property assets using LDA. FIG. 5 shows a plot of two groups, group A and group B, with two predictors or attributes, X₁ and X₂, on orthogonal axes. Inspecting the plot visually, members of group A tend to have larger values on the X₂ axis than members of group B. However, using X₂ as the sole predictor for group A or group B would yield poor results because the overlap (shaded area 530) of the distribution of X₂ for group A (curve 510) and the distribution of X₂ for group B (curve 520) is large, and this large overlap area (shaded area 530) represents a high probability of misclassifying an object or event from group A as belonging to group B, or vice versa. Therefore, X₂ is a poor discriminator between the two groups. Similarly, using X₁ as the sole predictor for one of the groups would yield unsatisfactory results because there is significant overlap (not shown in FIG. 5) between the two groups on axis X₁ as well. Therefore, in this example, an accurate separation using only one of the predictors may not be obtained.

In the simple illustrative example above, LDA finds a linear transformation of the two predictors or attributes (X₁ and X₂) that yields a new set of transformed values (discriminant scores or Z scores) that provides a more accurate discrimination than either predictor alone:

Z=f(X₁,X₂)=C₁*X₁+C₂*X₂

As shown in FIG. 5, the distribution of Z for group A (curve 550) and the distribution of Z for group B (curve 560) overlap each other. A cutting score 540 may be used to assign objects into group A or group B. For example, objects whose Z scores are below the cutting score are assigned to group A, while those with Z scores above the cutting score are assigned to group B. Note that the overlap (shaded area 570) of the distribution of Z for group A (curve 550) and the distribution of Z for group B (curve 560) is small in comparison to shaded area 530. Therefore, the linear transformation provides a better separation of group A and group B and the probability of misclassifying an object or event from group A as belonging to group B, or vice versa, is thus reduced.

Broadly speaking, LDA may estimate the relationship between a single dependent variable Y₁ and a set of independent variables, X₁ to Xₙ in this general form:

Y₁=X₁+X₂+X₃+ . . . +Xₙ

where Y₁ is a non-metric or categorical variable, i.e., a variable that changes from one categorical state to another, such as from good to bad, from high to low, from expensive to cheap, etc., and where X₁-Xₙ are metric variables, i.e., variables that take on values across a dimensional range, such as age, number of claims, or dollar amount. Independent variables may also be non-metric, for example, size of an entity, legal status of an asset, etc. In contrast to LDA, conventional regression analysis determines a metric or non-categorical dependent variable.

The linear combination for LDA, also known as a discriminant function or a variate, is derived from an equation that takes the following form:

Zⱼₖ=fⱼ(X₁ₖ,X₂ₖ, . . . Xₙₖ)=a+W₁X₁ₖ+W₂X₂ₖ+ . . . +WₙXₙₖ

where
Zⱼₖ=discriminant score of discriminant function j for object k (in this case k is the patent asset, which is identified by the patent number, publication number, and the like)
fⱼ( )=discriminant function j
a=intercept
Wᵢ=discriminant weight for independent variable i
Xᵢₖ=the independent variable i for object k
   It should be recognized that LDA calculates NG −1 discriminant functions, where NG is the number of groups in the dependent variable. For example, when there are two groups, LDA calculates one discriminant function and when there are three groups, LDA calculates two discriminant functions. A discriminant score (Zⱼₖ) is defined by a discriminant function fⱼ( ). A discriminant score is calculated for each object on each discriminant function, and is used in conjunction with the cutting score to determine predicted group membership. For example, in the case of a three-groups or levels dependent variable, each object will have a score for each discriminant function (discriminant functions one and two), allowing the objects to be plotted in two dimensions, with each dimension representing a discriminant function. Thus, LDA is not limited to a single variate (a single linear combination of variables), as in regression analysis, but creates multiple variates representing dimensions of discrimination among the groups.

LDA involves deriving discriminant function(s) that will discriminate well among multiple defined groups. Discrimination is achieved by setting the discriminant weight for each independent variable to maximize the between group variance relative to the within group variance. If the variance between the groups is large relative to the variance within the groups, it may be concluded that the discriminant function separates the groups well. For example, FIG. 6 shows two groups; members of each group are indicated by open circles and crosses respectively. Since the variance between the groups is large relative to the variance within the groups, the groups are well-separated by the discriminant function.

An exemplary test for the statistical significance of the discriminant function includes comparing the distribution of the discriminant scores for the two or more groups. Referring to FIG. 5, if the overlap in the distribution is small, then the discriminant function separates the groups well. (See shaded area 570). If the overlap is large, the function is a poor discriminator between the groups. (See shaded area 530).

FIG. 7 illustrates a flow chart of an exemplary process for constructing a patent scoring and classifying model, in accordance with an embodiment. At 710, the objective(s) of the scoring process is determined or selected. In one example, the objective is to classify patent assets into groups on the basis of their scores on a set of independent variables. For example, a company may want to acquire patent assets in a specific technological field and there are more candidate patent assets than it is willing to purchase. In this case, one objective is to classify the candidate patent assets into two or more groups based on predicted future monetary values of the patent assets. The set of independent variables may be patent asset attributes or features, such as the number of independent claims in a patent asset, the number of dependent claims, the age of a patent asset, etc. Once the candidate patent assets are classified, the outcome may be used to aid the management team in deciding what patent asset(s) to purchase.

In another example, a company may want to decide whether to continue to prosecute a few of its patent applications within its patent portfolio. In this case, one objective is to classify the patent applications into two groups based on the predicted chance of allowance of the patent applications. Once the patent applications are classified, the outcome may be used to aid the executives in deciding what patent application(s) to maintain in its patent portfolio. It should be recognized that the patent scoring process may be used to classify patent assets in many different ways. The above examples are not exhaustive. The scoring process is appropriate whenever the user may identify a single categorical/non-metric dependent variable and several metric or non metric independent variables, e.g., where the variables are related to patent assets.

In one example, a company may want to improve its patent strategy in order to maximize the value of its patent portfolio while keeping the cost of developing and maintaining its patent portfolio in check. For example, the company may be interested in determining whether reducing or limiting the number of pages in the patents, the number of patent family members, the number of clauses in the claims, or the like, may significantly reduce the overall value of its patent portfolio. In one example, the objective therefore is to determine whether statistically significant differences exist between the average score profiles on a set of variables for two (or more) a priori defined groups.

If high multi-collinearity exists between one independent variable (X₁) and the other independent variables in a discriminant function, then X₁ may be removed from the discriminant function without reducing significantly the discriminating power of the model. In one example, an objective therefore may include determining which of the independent variables account more for the differences in the average score profiles of the two or more groups. In another example, the objective may include determining the number and composition of the dimensions of discrimination between groups formed from a potential set of independent variables.

With continued reference to FIG. 7, LDA model design issues are considered at 720. These design issues may include one or more of the following: the selection of the dependent and independent variables of the discriminant function(s), the sample size, and the division of the sample into two sub-samples, one for estimating the discriminant function(s) and one for validating the overall discriminant model.

As described for LDA, the dependent variable is categorical (non-numerical) or at least can be converted to numerical values and the independent variables are typically numeric. In one example, the dependent variable may have two groups, such as patent applications that are eventually granted as patents versus patent applications that are eventually abandoned. In other examples, the dependent variable may involve more than two groups. In some examples, the dependent variables are true multichotomies and the groups are mutually exclusive and exhaustive without any modifications.

In one example, the market value of a group of patent assets may be used as a dependent variable and the attributes, or features, of the patent assets (patent metrics) may be used as independent variables. Because the market value of a group of patent assets is numerical, i.e., it can take on values across a continuous interval, the market value is converted to a categorical variable before discriminant analysis may be applied. In one example, discriminant analysis is applied by comparing the upper quartile patents with the rest of the patent assets by using the upper quartile Q3 value (market/sale price) as the categorical divider or cutoff (dividing high value from low value based on the upper quartile cutoff). In other examples, different categorical variables with three or more groups may be created by using the upper quartile value Q3, the median value Q2, the 60^{th} percentile P₆₀, and the 80^{th} percentile P₈₀ as market value dividers. In yet another example, a categorical variable may be created to include only two polar extreme groups, such as a group of patent assets within the top tenth percentile in market value and a group within the bottom tenth percentile in market value, and the patent assets that fall outside of these two extreme groups are excluded.

The independent variables are generally metric variables. They are attributes or features (patent metrics) associated with the value and quality of patent assets. These attributes may be determined based on different studies and observations. For example, a review of extant literature and statistical analysis of the relationship between identified patent attributes and actual patent asset values in the market may yield a set of patent attributes for discriminant analysis.

The patent attributes may also be determined based on interviews with patent holders, intellectual property (IP) asset managers, IP attorneys, and other experts. Secondary data research, observations of current trends of patent activities in specific fields, qualitative inferences, and experience may also yield additional patent attributes. A non-exhaustive set of exemplary patent attributes is listed in Table 1.

TABLE 1

| | |
|---|---|
| Age of the patent (in years) | Time taken for grant (in years |
| Seminality of the patented | Number of inventors |
| technology (Earliest priority) | |
| Number of independent claims | Number of dependent claims |
| Number of clauses in the first | Number of words in the first |
| independent claim | independent claim |
| Number of different words in the | Number of pages in the patent |
| first independent claim | |
| Number of annuities paid | Number of family members |
| Legal status | Number of reassignments |
| Number of office action | Number of forward citations |
| amendments (Number of | |
| non-final rejections) | |
| Number of backward citations | Number of foreign backward citations |
| Number of non patent literature | Trends of number of granted patents |
| backward citations | and applications for each year in |
| | the last 10 years |
| Recent citations | Average age of backward citations |
| Average age of forward citations | Entity size |
| Number of independent claims | Ratio of independent claims retained |
| retained in the latest amendment | and independent claims filed |
| Nature of Office Action (non-final, | Whether a request for continued |
| final, or restriction action) | examination (RCE) has been filed? |
| Whether an appeal has been filed? | Number of Objections/Rejections |
| Nature of and frequency of claims | Number of times independent claims |
| rejections under specific patent | have been amended by Applicant |
| laws (§102/§103/§112) | |
| Ratio of words before amendments | Number of consecutive actions in |
| and after amendments | which a reference has remained |
| | the primary reference relied upon |
| | by Examiner |
| Number of citations cited by the | Which Office Action is this? |
| Examiner | (first, second, and so on) |
| Confidence in the Examiner's | Number of drawings |
| action: Number of Office Actions | |
| per year since filing and Examiner | |
| experience indicated by number | |
| of granted patents examined | |
| Number of statutory classes | Number of international classes |
| | classified into |
| Number of U.S. classes classified | Density (number of patents and |
| into | applications in the U.S. class in |
| | the last 10 years) |
| Number of granted patents in the | Trend of patents granted in a U.S. |
| family | class based on year wise patent |
| | grants, in the last 10 years |
| | (analysis of technological trend) |
| Ratio of density of an entity's | Ratio of forward citations to |
| own portfolio in this technology to | backward citations |
| overall patents in this technology | |
| Recent forward citation by age | Distinct U.S. or PTO-specific class |
| of the patent in years | |
| Distinct IPC class | Ratio of patent's claims to median |
| | number of claims in the same class |
| Average time lag to receive | Average Forward citations of the |
| forward citations | Backward citing patents |
| Legal Status of the forward | Age adjusted Average Forward |
| citing patents | citations of the Backward citing |
| | patents |
| Average Forward citations of the | Ratio of Number of Backward citing |
| Forward citing patents | patents lapsed before the completion |
| | of their legal life to total number of |
| | Backward citing patents |
| Age adjusted Average Forward | Average time lag of Backward citing |
| citations of the Forward citing | patent before they receive citation |
| patents | |
| Ratio of Number of Forward | Family Citations |
| citing patents lapsed before the | |
| completion of their legal life | |
| to Total number of Forward | |
| citing patents | |

Another LDA model design issue that may be considered at 720 in FIG. 7 is the size of the sample set. Typically, LDA is sensitive to the ratio of the sample size to the number of independent variables. In general, there should be twenty or more observations for each independent variable in order to avoid unstable results. The minimum size recommended is five observations per independent variable, and this ratio applies to all variables considered in the analysis, even if all of the variables considered are not entered into the discriminant function (such as in stepwise estimation). In addition to the overall sample size, the group size should generally exceed the number of independent variables.

Another LDA model design issue considered at 720 in FIG. 7 is the division of the sample into two sub-samples, one for estimating the discriminant function(s) and one for validating the overall discriminant model. Further, in one example, the sample is randomly divided into two groups, one for model estimation (analysis sample) and the other for model validation (holdout sample). Thus, the one or more test set of intangible assets comprises an analysis sample and a holdout sample. This method of validating the function is known as the cross-validation approach. The division between the groups may be 50-50, 60-40, 75-25, or the like. In one example, the sizes of the groups selected for the holdout sample is proportionate to the total sample distribution.

It is noted that LDA typically works well when a few basic assumptions are met. For example, LDA generally assumes, but does not require, that the independent variables have a multivariate normal distribution. LDA also generally assumes, but does not require, that the groups have equal covariance matrices. In general, LDA works well when multi-collinearity among the independent variables is small, i.e., the independent variables are not highly correlated such that one independent variable can be predicted by the other independent variables. With continued reference to FIG. 7, the discriminant function(s) is derived and the LDA model is assessed for overall fit to actual data at 730. For example, the discriminant function weights are estimated and the statistical significance and validity of the LDA model are determined. In one example, the discriminant function(s) is computed by a simultaneous estimation method in which all of the independent variables are considered simultaneously. In this method, the discriminant function(s) is computed based upon the entire set of independent variables, regardless of the discriminating power of each independent variable. This method is appropriate when elimination of the less discriminating independent variables from the model is not required. In another example, the discriminant function(s) is computed by a stepwise estimation method in which the independent variables with the highest discriminating power are entered into the discriminant function sequentially.

After the discriminant function(s) is estimated, the statistical significance of the discriminant model as a whole and the statistical significance of each of the estimated discriminant functions may be determined. As discussed earlier, LDA estimates NG −1 discriminant functions, where NG is the number of groups in the dependent variable. For example, when there are two groups, LDA calculates one discriminant function and when there are three groups, LDA calculates two discriminant functions. If one or more functions are not statistically significant, then the discriminant model is re-estimated with the number of functions limited to the number of significant functions. There are a number of criteria with which to assess statistical significance, including but not limited to Roy's greatest characteristic root, Wilks' lambda, Hotelling's trace, and Pillari's criterion. In one example, Wilks' lambda significance value is noted for each of the independent variables and a significance criterion of 0.05 is used. Only those independent variables that are statistically significant are included in the discriminant model and their discriminant weights extracted.

It should be recognized that statistical significance in the overall model and the discriminant function(s) does not necessarily mean that the prediction accuracy of the model is acceptable. Therefore, in one example, after the statistical significance has been determined, the prediction accuracy of the model may be estimated using classification matrices.

As discussed earlier, the sample may be split into an analysis sample and a holdout sample. The analysis sample is used in constructing the discriminant function(s). The weights derived from the analysis sample would be applied to score and classify the holdout sample. The holdout sample's scoring and classification used to construct a classification matrix which contains the number of correctly classified and incorrectly classified patent assets vis-à-vis their known market values. The percentage of correctly classified patent assets is typically called the hit ratio. The higher the hit ratio, the higher the prediction accuracy.

The discriminant score for each patent asset in the holdout sample may be calculated by multiplying the discriminant weights calculated from the analysis sample by their corresponding independent variables in the holdout sample. In one example, if the discriminant score for a patent asset in the holdout sample is less than the cutting score, the patent asset is classified as a low value patent asset, and if the score is greater than the cutting score, the patent asset is classified as a high value patent asset. Because the market values of the patent assets within the holdout sample are known, the number of correctly classified patent assets may be found, and thus the hit ratio may be determined. In one example, a hit ratio of 85% or higher may be considered satisfactory. In another example, the hit ratio may be compared to the probability that a patent asset could be classified correctly by mere chance, i.e., without the aid of the discriminant function, to assess the overall fit of the model. In a simple case where the sample sizes of the groups are equal, the probability of classifying correctly by chance is estimated as one divided by the number of groups. For example, in a two-group function, the probability would be 0.5 and for a three-group function the probability would be 0.33.

With continued reference to FIG. 7, the relative importance of each independent variable in discriminating between the groups is examined at 740. In one example, the magnitude of the discriminant weight for each independent variable in the discriminant function is examined. Note that the sign of the discriminant weight denotes whether the corresponding independent variable makes a positive or a negative contribution. The magnitude of the discriminant weight represents the relative contribution of the corresponding independent variable to the discriminant function. Therefore, independent variables with relatively larger weights contribute more to the discriminating power of the discriminant function than do independent variables with smaller weights.

In another example, discriminating loadings (also known as structure coefficients or structure correlations) may be used as discriminant weights to assess the relative contribution of each independent variable to the discriminant function. Discriminant loadings estimate the correlations between a given independent variable and the discriminant scores associated with a given discriminant function. Discriminant loadings reflect the variance that the independent variables share with the discriminant function and can be interpreted like factor loadings.

In yet another example, partial F values may be used to assess the associated level of significance for each variable when the stepwise estimation method (as opposed to the simultaneous estimation method) is used. A partial F test is used to determine the partial F values, and is an F test for the additional contribution to prediction accuracy of a variable above that of the variables already in the discriminant function. The absolute sizes of the significant F values are examined and ranked. Large F values indicate greater discriminating power.

With continued reference to FIG. 7, the discriminant results may be validated to provide assurances that the results have external as well as internal validity at 750. For example, in certain embodiments, cross-validation may be applied to identify and to correct instances where the discriminant analysis inflates the hit ratio when evaluated only on the analysis sample. Accordingly, the data set can be divided randomly into analysis and holdout samples, the holdout sample used for validation. The validation generally determining whether particular variables are good discriminators for the particular objectives, and those variables that are not good discriminators may be removed. Validation may be carried out by applying one or more of: Analysis of Variance (ANOVA), Wilk's Test of equality of means, Automatic interaction detector, CHi-squared Automatic Interaction Detector (CHAID), clustering, Spearman's rank correlation, or other validation techniques.

Still referring back to FIG. 7, a patent score may be determined for a patent asset at 760 using a discriminant function that has been derived, tested for statistical significance and predictive accuracy, validated, etc. In one example, a patent asset may be ranked based on the score, where a higher score receives a higher rank. In one example, a patent asset may be classified into one of at least two groups of patent assets by comparing the patent score with a cutting score. For example, if the patent score is less than a cutting score, then the patent asset belongs to a first group, and if the patent score is larger than the cutting score, then the patent asset belongs to a second group.

It should be recognized that in some examples, some of the steps described in above may be performed in a different order or may be performed simultaneously instead of sequentially. For example, the relative importance of each independent variable in discriminating between the groups (740 in FIG. 7) may be examined before the statistical significance or the predictive accuracy is assessed (730 in FIG. 7). In some examples, some of the steps described above may be repeated. For example, the discriminant function(s) may be calculated (730 in FIG. 7) again after the relative importance of each independent variable in discriminating between the groups (740 in FIG. 7) is examined. In some examples, certain steps may be omitted, e.g., the LDA model may be constructed without evaluating the importance of each independent variable (740 in FIG. 7) and/or validating the discriminant results (750 in FIG. 7). Further, a constructed LDA model may be used to score patent assets without actually classifying target patent assets.

It will be recognized that exemplary processes and systems for constructing and/or using an LDA model may be carried out in a server-client environment, e.g., across a network such as the Internet. A suitable interface for constructing and/or using an LDA model may include, for example, a web-browser interface. Further, patent assets may be retrieved from a patent asset data collection, e.g., a remote or local database to the client and/or server.

Many of the techniques described here may be implemented in hardware or software, or a combination of the two. Preferably, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices. Moreover, each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

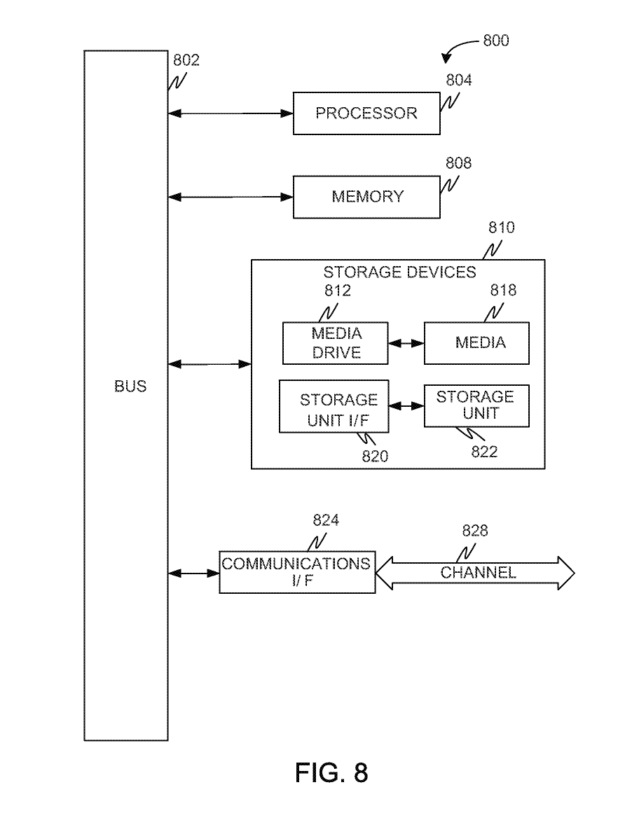

FIG. 8 illustrates an exemplary computing system 800 that may be employed to implement processing functionality for various embodiments of the invention (e.g., as a SIMD device, client device, server device, one or more processors, or the like). Those skilled in the relevant art will also recognize how to implement the invention using other computer systems or architectures. Computing system 800 may represent, for example, a user device such as a desktop, mobile phone, personal entertainment device, DVR, and so on, a mainframe, server, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, preferably random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

Computing system 800 may also include information storage mechanism 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. A storage media 818 may include, for example, a hard disk, floppy disk, magnetic tape, optical disk, CD or DVD, or other fixed or removable medium that is read by and written to by media drive 812. As these examples illustrate, storage media 818 may include a computer-readable storage medium having stored therein particular computer software or data.

In alternative embodiments, information storage mechanism 810 may include other similar instrumentalities for allowing computer programs or other instructions or data to be loaded into computing system 800. Such instrumentalities may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from removable storage unit 822 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical, or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 808, storage device 818, storage unit 822, or signal(s) on channel 828. These and other forms of computer-readable media may be involved in providing one or more sequences of one or more instructions to processor 804 for execution. Such instructions, generally referred to as “computer program code” (which may be grouped in the form of computer programs or other groupings), when executed, enable computing system 800 to perform features or functions of embodiments of the present invention.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by processor 804, causes processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for classifying intangible assets, the method comprising:
determining an objective of classification;
constructing, via a processor, a discriminant analysis (DA) model using one or more test sets of intangible assets, wherein the DA model comprises at least one discriminant function operable to classify the one or more test sets of intangible assets into at least two groups based on a set of attributes associated with at least one intangible asset of the one or more test sets of intangible assets to meet the objective of classification; and
classifying a target set of intangible assets via the DA model.

2. The method of claim 1, wherein the objective of classification comprises a potential valuation, a litigation likelihood, a litigation outcome, a potential commercialization, and a subsequent renewal/abandonment decision.

3. The method of claim 1, wherein one of the one or more test sets of intangible assets is associated with one of the objective of classification.

4. The method of claim 1, wherein the discriminant analysis (DA) model comprises a linear discriminant analysis (LDA) model and wherein the at least one discriminant function comprises at least one linear discriminant function.

5. The method of claim 1, wherein the at least one discriminant function comprises a combination of weighted attributes from the set of attributes.

6. The method of claim 5, wherein constructing the DA model comprises determining a weight for at least one attribute of the set of attributes.

7. The method of claim 6, wherein determining the weight comprises determining a correlation between an attribute having an unknown weight and an attribute having a known weight and applying a correlation factor to determine the weight of the attribute having the unknown weight based on the weight of the attribute having the known weight.

8. The method of claim 1, wherein classifying one of the test and the target set of intangible assets comprises determining an output score of the DA model for each intangible asset in one of the test and the target set of intangible assets and segmenting one of the test and the target set of intangible assets into two or more groups based on the output score determined for each intangible asset.

9. The method of claim 1, wherein each of the one or more test sets of intangible assets comprises a plurality of intangible assets having one of a known value, a known outcome, a pre-defined value, and a predefined outcome for a given objective.

10. The method of claim 9, wherein constructing the DA model comprises determining a predictive power of the DA model by validating the classification of the test set of intangible assets based on the DA model against one of the known value, the known outcome, the pre-defined value, and the pre-defined outcome.

11. The method of claim 10, wherein constructing the DA model comprises iteratively refining the at least one discriminant function such that the predictive power of the DA model is within a pre-defined acceptable limit.

12. The method of claim 11, wherein the iteratively refining the at least one discriminant function comprises, for at least one attribute of the set of attributes, adjusting a weight associated with a corresponding attribute.

13. The method of claim 1, wherein constructing the DA model comprises validating the DA model using a plurality of statistical tools.

14. The method of claim 13, wherein the plurality of statistical tools comprises one of an Analysis of Variance (ANOVA) test, a Spearman's rank correlation test, a Chi-squared Automatic Interaction Detector (CHAID) test, and a Wilk's lamba test.

15. The method of claim 1, wherein the constructing the DA model is performed specific to a particular technology domain.

16. A method for constructing a discriminant analysis (DA) model for classifying intangible assets, the method comprising:
deriving, via a processor, at least one discriminant function operable to classify a test set of intangible assets into at least two groups based on a set of attributes associated with at least one intangible asset of the test set of intangible assets, the at least one discriminant function comprising a combination of weighted attributes from the set of attributes.

17. The method of claim 16, further comprising determining an objective of classification, and wherein the deriving the at least one discriminant function comprises deriving the at least one discriminant function to meet the objective of classification.

18. The method of claim 16, wherein deriving the at least one discriminant function comprises determining a weight for at least one attribute of the set of attributes.

19. The method of claim 16, further comprising determining a predictive power of the DA model by validating the classification of the test set of intangible assets based on the DA model against one of a known value, a pre-defined value, a known outcome, and predefined outcome of the test set of intangible assets.

20. The method of claim 19, wherein deriving comprises iteratively refining the at least one discriminant function such that the predictive power of the DA model is within a pre-defined acceptable limit.

21. The method of claim 16 further comprising validating the DA model using a plurality of statistical tools.

22. A method for classifying intangible assets, the method comprising:
classifying a set of intangible assets based on a discriminant analysis (DA) model via a processor, the DA model comprising at least one discriminant function operable to classify the set of intangible assets into at least two groups based on a set of attributes associated with at least one intangible asset of the set of intangible assets.

23. The method of claim 22, further comprising determining an objective of classification and wherein the DA model is configured to meet the objective of classification.

24. The method of claim 22, wherein classifying the set of intangible assets comprises generating an output score of the DA model for each of the intangible assets and segmenting into two or more groups the set of intangible assets based on the output score.

25. A discriminant analysis (DA) model for classifying intangible assets, the DA model comprising:
at least one discriminant function operable to classify a set of intangible assets into at least two groups based on a set of attributes associated with each intangible asset of the set of intangible assets, the at least one discriminant function comprising a combination of weighted attributes from the set of attributes.

26. The DA model of claim 25, wherein the DA model comprises a linear discriminant analysis (LDA) model, and wherein the at least one discriminant function comprises at least one linear discriminant function.

27. A computer-readable storage medium comprising computer-executable instructions for classifying intangible assets, the instructions comprising:
constructing a discriminant analysis (DA) model using one or more test sets of intangible assets, wherein the DA model comprises at least one discriminant function operable to classify the one or more test sets of intangible assets into at least two groups based on a set of attributes associated with at least one intangible asset of the one or more test sets of intangible assets; and
classifying a target set of intangible assets via the DA model.

28. An apparatus for classifying intangible assets, the apparatus comprising:
a processor configured to:
construct a discriminant analysis (DA) model using one or more test sets of intangible assets, wherein the DA model comprises at least one discriminant function operable to classify the one or more test sets of intangible assets into at least two groups based on a set of attributes associated with at least one intangible asset of the one or more test sets of intangible assets; and
classify a target set of intangible assets via the DA model.

29. An apparatus for classifying intangible assets, the apparatus comprising:
means for constructing a discriminant analysis (DA) model using one or more test sets of intangible assets, wherein the DA model comprises at least one discriminant function operable to classify the one or more test sets of intangible assets into at least two groups based on a set of attributes associated with at least one intangible asset of the one or more test sets of intangible assets; and
means for classifying a target set of intangible assets via the DA model.
